(19) United States
(12) Patent Application Publication
(10) Pub. No.: US 2022/0362636 A1
(43) Pub. Date: Nov. 17, 2022

(54) Negative Poisson`s Ratio Materials For Sporting Goods

(71) Applicant: Joon Bu Park, Las Vegas, NV (US)

(72) Inventor: Joon Bu Park, Las Vegas, NV (US)

(21) Appl. No.: 17/317,460

(22) Filed: May 11, 2021

(51) Int. Cl. A63B 37/06; A63B 37/00; A63B 53/04; B33Y 80/00; B29C 43/02

(52) U.S. Cl. CPC A63B 37/06; A63B 37/0051; A63B 53/0445; B33Y 80/00; B29C 43/02; A63B 2037/065; A63B 2209/00; A63B 2102/18

(57) ABSTRACT

In an aspect, a sports ball includes a core including a negative Poisson's ratio (NPR) foam material, in which the core has a Poisson's ratio of between 0 and −1, and in which the NPR foam material includes an NPR polymer foam; and a cover layer surrounding the core. In an aspect, a golf club includes an elongated shaft; a grip disposed at a first end of the elongated shaft; and a head connected to a second end of the elongated shaft, the head having a flat face configured for contact with a golf ball, in which the flat face is formed of a negative Poisson's ratio (NPR) foam material, in which the head has a Poisson's ratio of between 0 and −1, and in which the NPR foam material includes an NPR metal foam, an NPR ceramic foam, or an NPR-PPR composite foam.

### BACKGROUND

The present disclosure relates generally to materials for and construction of various types of sporting goods, including balls, such as golf balls, baseballs, softballs, etc., and golf clubs.

Balls and other types of sporting goods are used for various sporting and leisure activities that are played and watched by a large portion of the population.

### SUMMARY

We describe here sporting goods, such as sports balls, that are formed of materials having a negative Poisson's ratio (“NPR materials”). For instance, the core of a golf ball can be formed of an NPR material. This composition facilitates efficient energy transfer from a golf club to the golf ball, thereby enabling the golf ball to be launched and to travel a long distance upon impact by the golf club. This composition also provides impact resistance and durability. In some examples, sports balls can be formed of composite materials that include both NPR materials and materials with positive Poisson's ratios (“PPR materials”) to achieve desired performance characteristics, such as aerodynamic properties (e.g., launch distance) or durability.

In an aspect, a sports ball includes a core including a negative Poisson's ratio (NPR) foam material, in which the core has a Poisson's ratio of between 0 and −1, and in which the NPR foam material includes an NPR polymer foam; and a cover layer surrounding the core.

Embodiments can include one or any combination of two or more of the following features.

The NPR foam material includes an NPR rubber foam. The NPR rubber foam includes one or more of butadiene, polybutadiene, or styrene-butadiene.

The NPR foam material includes a thermoplastic polymer NPR foam or a viscoelastic elastomer NPR film.

The core has a Poisson's ratio of between 0 and −0.8.

The NPR foam material is composed of a cellular structure having a characteristic dimension of between 0.1 μm and 3 mm.

The core includes a composite material including the NPR foam material and a positive Poisson's ratio (PPR) material.

The sports ball includes a middle layer surrounding the core and disposed between the core and the cover. The middle layer includes second NPR foam material.

The cover is formed of a third NPR foam material.

The ball includes a golf ball.

The ball includes a baseball or a softball.

The ball includes a cricket ball.

In an aspect, a method of making a sports ball includes forming a core of a sports ball from a negative Poisson's ratio (NPR) foam material, in which the NPR foam material includes an NPR polymer foam, and in which the core has a Poisson's ratio of between 0 and −1; and disposing a cover to surround the core of the sports ball.

Embodiments can include one or any combination of two or more of the following features.

Forming the core from an NPR material includes heating and compressing a positive Poisson's ratio (PPR) foam material to form the NPR material.

Forming the core from an NPR material includes forming the core from nano- or micro-structured PPR materials.

Forming the core from an NPR material includes forming the core using an additive manufacturing technique.

In an aspect, a golf club includes an elongated shaft; a grip disposed at a first end of the elongated shaft; and a head connected to a second end of the elongated shaft, the head having a flat face configured for contact with a golf ball, in which the flat face is formed of a negative Poisson's ratio (NPR) foam material, in which the head has a Poisson's ratio of between 0 and −1, and in which the NPR foam material includes an NPR metal foam, an NPR ceramic foam, or an NPR-PPR composite foam.

Embodiments can include one or any combination of two or more of the following features.

The head is formed of an NPR metal foam or an NPR ceramic foam. The head is formed of an NPR-PPR composite material.

The flat face is integral with the head.

Dimples are defined on one or more surfaces of the golf club. The flat face does not have dimples. Dimples are defined on a surface of the elongated shaft of the golf club. Dimples are defined on the head of the golf club.

Other implementations are within the scope of the claims.

### DESCRIPTION OF DRAWINGS

FIG. 1 is a diagram of several sports balls.

FIG. 2 is an illustration of materials with negative and positive Poisson's ratios.

FIG. 3 is an illustration of balls with negative and positive Poisson's ratios.

FIGS. 4A and 4B are plots of diameter versus time.

FIG. 5 is a cross-sectional view of a two-piece golf ball.

FIG. 6 is a cross-sectional view of a three-piece golf ball.

FIG. 7 is a cross-sectional view of a baseball.

FIG. 8 is a cross-sectional view of a softball.

FIG. 9 is a cross-sectional view of a cricket ball.

FIG. 10 is a diagram of a method of making a ball.

FIG. 11 is a diagram of a golf club.

FIG. 12 is a diagram of a portion of a golf club.

FIG. 13 is an illustration of portions of golf clubs with materials with negative and positive Poisson's ratios.

FIG. 14 is a diagram of a golf club.

FIG. 15 is a diagram of a golf club.

### DETAILED DESCRIPTION

We describe here sports balls, such as golf balls, that are formed of materials having a negative Poisson's ratio (“NPR materials,” also referred to as auxetic materials). For instance, the core of a golf ball can be formed of an NPR material. This composition facilitates efficient energy transfer from a golf club to the golf ball, thereby enabling the golf ball to be launched a long distance upon impact by the golf club. This composition also provides impact resistance and durability. In some examples, sports balls can be formed of composite materials that include both NPR materials and materials with positive Poisson's ratios (“PPR materials”) to achieve target performance characteristics, such as aerodynamic properties (e.g., launch distance) or durability.

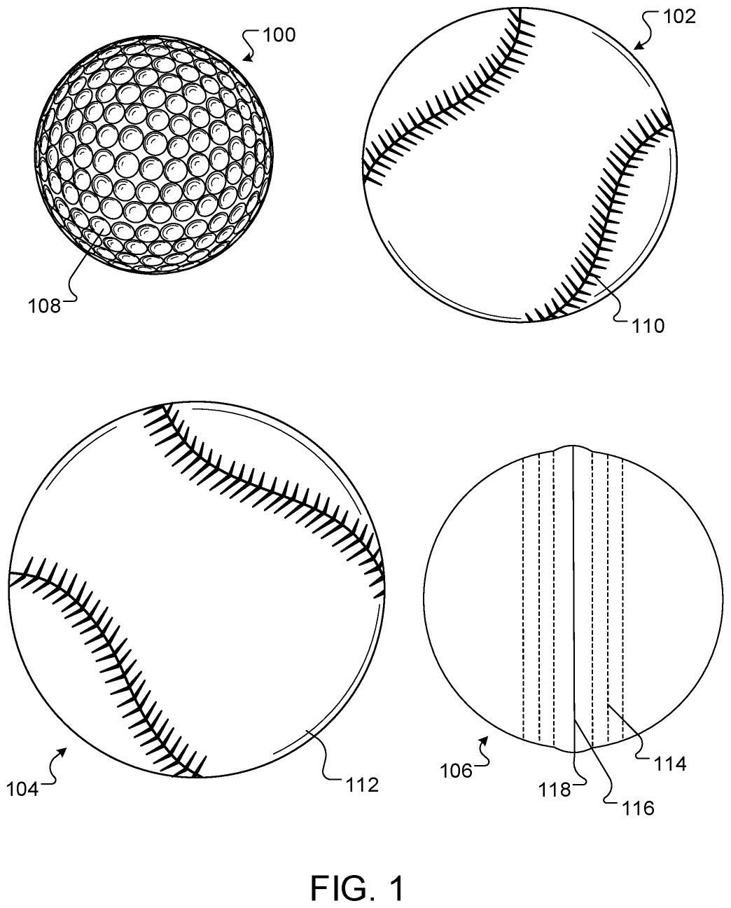

Referring to FIG. 1, several sports balls are shown, including a golf ball 100, a baseball 102, a softball 104, and a cricket ball 106. These sports balls are examples of the types, shapes, and sizes of balls into which the NPR materials described here can be integrated.

The golf ball 100 can have a diameter of about 1.68 inches, about 1.7 inches, etc. The minimum size of a golf ball as regulated by the United States Golf Association is 1.68 inches. Any diameter of at least about 1.68 inches is appropriate for the golf ball 100. The outer surface of the golf ball 100 includes dimples 108 which improve the aerodynamic properties of the golf ball. The golf ball 100 can have different numbers, shapes, and sizes of dimples to achieve different aerodynamic effects. For example, the golf ball can have about 250 dimples, about 300 dimples, about 400 dimples, 500 dimples, 1000 dimples, etc. In the illustrated example, the dimples 108 on the golf ball are elliptical and non-uniform in dimension. In some examples, the dimples 108 are uniform dimension. In some implementations, the dimples 108 are circular, triangular, hexagonal, or any other suitable shape, e.g., a shape that impacts the aerodynamic properties of the ball. In the illustrated example, the dimples 108 on the golf ball are generally uniformly spaced. In some examples, the dimples 108 are irregularly spaced.

The baseball 102 has a diameter of about 2.75 inches, but can have other diameters (e.g., about 2.8 inches, about 3 inches, etc.). The softball 104 has a diameter of about 3.5 inches, but can have other diameters (e.g., about 3.6 inches, about 3.8 inches, etc.). The cricket ball 106 has a diameter of about 2.8 inches, but can have other diameters (e.g., about 2.86 inches, etc.). The cricket ball 106 is not perfectly spherical and includes a ridge 118 elevated along the center of the cricket ball 106.

Sports balls can be manufactured using various techniques. Many sports balls have stitches holding their cover together. The baseball 102 has stitches 110 in one continuous seam. A regulation baseball has 108 double stitches, or 216 individual stitches. The softball 104 has stitches 112 in one continuous seam. A regulation softball has 88 stitches. The cricket ball 106 has stitches 114 in six seams: three seams on either side of a centerline 116 of the ball. The cricket ball 106 can have various numbers of stitches: for example, about 55 stitches, about 78 stitches, about 82 stitches, etc.

Sports balls are often multi-layer structures, e.g., with a core and a cover, or with multiple interior layers and a cover. One or more of the layers of a sports ball can be formed of a material with a negative Poisson's ratio (referred to as an “NPR material” or an “auxetic material”). An NPR material is a material that has a Poisson's ratio that is less than zero, such that when the material experiences a positive strain along one axis (e.g., when the material is stretched), the strain in the material along the two perpendicular axes is also positive (e.g., the material expands in cross-section). Conversely, when the material experiences a negative strain along one axis (e.g., when the material is compressed), the strain in the material along a perpendicular axis is also negative (e.g., the material compresses along the perpendicular axis). By contrast, a material with a positive Poisson's ratio (a “PPR material”) has a Poisson's ratio that is greater than zero. When a PPR material experiences a positive strain along one axis (e.g., when the material is stretched), the strain in the material along the two perpendicular axes is negative (e.g., the material compresses in cross-section), and vice versa.

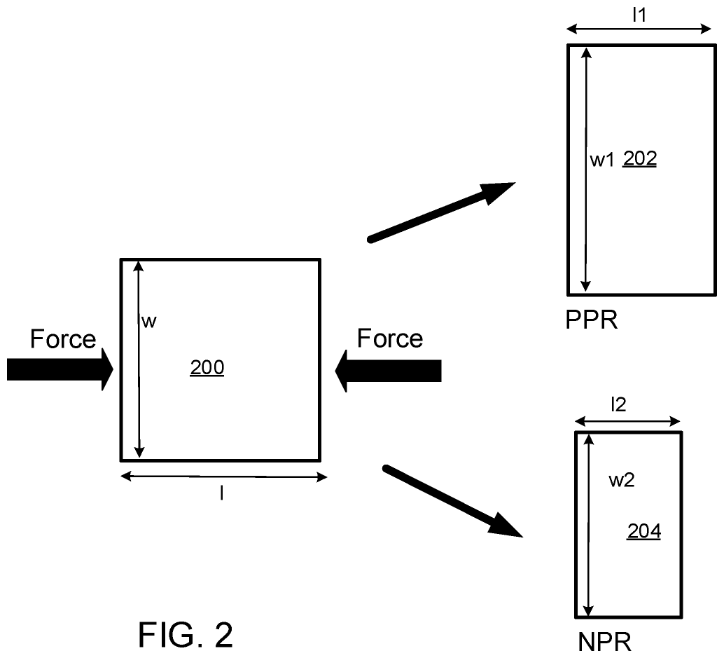

Materials with negative and positive Poisson's ratios are illustrated in FIG. 2, which depicts a hypothetical two-dimensional block of material 200 with length l and width w.

If the hypothetical block of material 200 is a PPR material, when the block of material 200 is compressed along its width w, the material deforms into the shape shown as block 202. The width w1 of block 202 is less than the width w of block 200, and the length l1 of block 202 is greater than the length l of block 200: the material compresses along its width and expands along its length.

By contrast, if the hypothetical block of material 200 is an NPR material, when the block of material 200 is compressed along its width w, the material deforms into the shape shown as block 204. Both the width w2 and the length l2 of block 204 are less than the width w and length l, respectively, of block 200: the material compresses along both its width and its length.

NPR materials for sports balls can be foams, such as polymeric foams, ceramic foams, metallic foams, or combinations thereof. A foam is a multi-phase composite material in which one phase is gaseous and the one or more other phases are solid (e.g., polymeric, ceramic, or metallic). Foams can be closed-cell foams, in which each gaseous cell is sealed by solid material; open-cell foams, in which the each cell communicates with the outside atmosphere; or mixed, in which some cells are closed and some cells are open.

An example of an NPR foam structure is a re-entrant structure, which is a foam in which the walls of the cells are concave, e.g., protruding inwards toward the interior of the cells. In a re-entrant foam, compression applied to opposing walls of a cell will cause the four other, inwardly directed walls of the cell to buckle inward further, causing the material in cross-section to compress, such that a compression occurs in all directions. Similarly, tension applied to opposing walls of a cell will cause the four other, inwardly directed walls of the cell to unfold, causing the material in cross-section to expand, such that expansion occurs in all directions. NPR foams can have a Poisson's ratio of between −1 and 0, e.g., between −0.8 and 0, e.g., −0.8, −0.7, −0.6, −0.5, −0.4, −0.3, −0.2, or −0.1. NPR foams can have an isotropic Poisson's ratio (e.g., Poisson's ratio is the same in all directions) or an anisotropic Poisson's ratio (e.g., Poisson's ratio when the foam is strained in one direction differs from Poisson's ratio when the foam is strained in a different direction).

An NPR foam can be polydisperse (e.g., the cells of the foam are not all of the same size) and disordered (e.g., the cells of the foam are randomly arranged, as opposed to being arranged in a regular lattice). An NPR foam can have a characteristic dimension (e.g., the size of a representative cell, such as the width of the cell from one wall to the opposing wall) ranging from 0.1 μm to about 3 mm, e.g., about 0.1 μm, about 0.5 μm, about 1 μm, about 10 μm, about 50 μm, about 100 μm, about 500 μm, about 1 mm, about 2 mm, or about 3 mm.

Examples of polymeric foams for sports balls include thermoplastic polymer foams (e.g., polyester polyurethane or polyether polyurethane); viscoelastic elastomer foams; or thermosetting polymer foams such as silicone rubber. Examples of metallic foams for sports balls include metallic foams based on copper, aluminum, or other metals, or alloys thereof.

NPR-PPR composite materials are composites that include both regions of NPR material and regions of PPR material. NPR-PPR composite materials can be laminar composites, matrix composites (e.g., metal matrix composites, polymer matrix composites, or ceramic matrix composites), particulate reinforced composites, fiber reinforced composites, or other types of composite materials. In some examples, the NPR material is the matrix phase of the composite and the PPR material is the reinforcement phase, e.g., the particulate phase or fiber phase. In some examples, the PPR material is the matrix phase of the composite and the NPR material is the reinforcement phase.

The compressibility of a ball affects the elastic deformation (e.g., compression) experienced by the ball when it is struck (e.g., by a bat or club). A suitable amount of deformation enables efficient energy transfer from the striking object (e.g., bat or club) to the ball without sacrificing the aerodynamic shape of the ball, thus enabling the ball to travel a desirable distance (referred to as the “launching distance”), e.g., a long distance. A ball that is rigid will have little to no deformation when struck, preventing significant energy transfer to the ball and causing the ball to have a short launching distance. A highly elastic ball will have a large amount deformation when struck, absorbing significant energy and undergoing a change in its aerodynamic structure, which can also result in a short launching distance. To design a ball that is capable of having a desirable launching distance, the material of the ball can be selected to balance rigidity and elasticity.

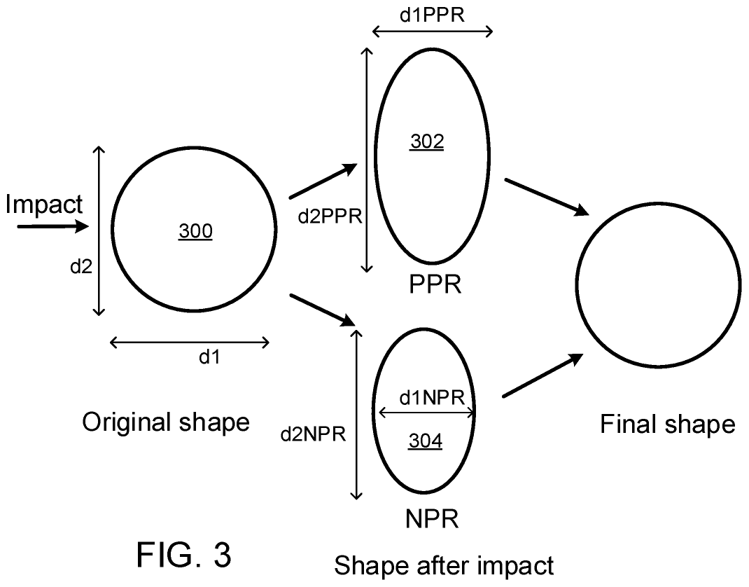

NPR materials can exhibit various desirable properties, including high shear modulus, effective energy absorption, and high toughness (e.g., high resistance to indentation, high fracture toughness), among others. The energy absorption characteristics of NPR materials are such that when a ball formed at least partially of an NPR material (an “NPR ball”) is struck (e.g., by a bat or club), the ball undergoes a different (e.g., smaller) change in diameter than a comparable ball formed of PPR material (a “PPR ball”). FIG. 3 shows a schematic depiction of the change in diameter of a ball 300 upon impact. Prior to impact, the ball 300 has a diameter d1 in the direction of the impact and a diameter d2 in the direction perpendicular to the impact. If the ball 300 is a PPR ball, the ball undergoes significant deformation (e.g., elastic deformation) into a shape 302, such that the diameter in the direction of the impact decreases to d1PPR and the diameter in the direction perpendicular to the impact increases to d2PPR. By contrast, if the ball 300 is an NPR ball, the ball undergoes less extensive deformation into a shape 304. The diameter of the shape 304 in the direction of the impact decreases to d1NPR, which is approximately the same as d1PPR. However, the diameter of the shape 304 in the direction perpendicular to the impact also decrease, to d2NPR. The magnitude of the difference between d2 and d2NPR is less than the magnitude of the difference between d2 and d2PPR, meaning that the NPR ball undergoes less deformation than the PPR ball. This reduction in total deformation that is achievable by an NPR ball enables the NPR ball to have a different (e.g., longer) launching distance than an otherwise comparable PPR ball at least in part because the NPR ball has a lower wind resistance due to its smaller diameter upon compression.

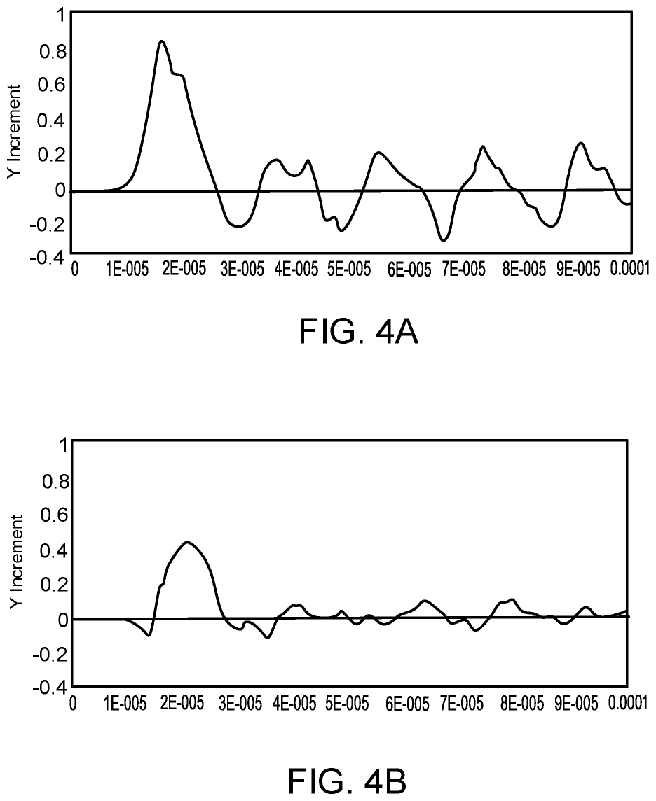

FIGS. 4A and 4B show plots of diameter versus time for a PPR ball with a Poisson's ratio of 0.45 and an NPR ball with a Poisson's ratio of −0.45, respectively, responsive to being struck with an equivalent force. In this example, the NPR ball undergoes a smaller initial change in diameter than does the PPR ball, and the oscillations in diameter are smaller in magnitude and dampen more quickly.

NPR materials can be incorporated into sports balls, such as golf balls, baseballs, softballs, cricket balls, or other balls, such as balls that are subject to impact during play. The NPR composition of the balls helps to facilitate a different (e.g., longer) launching distance than, e.g., comparable PPR balls.

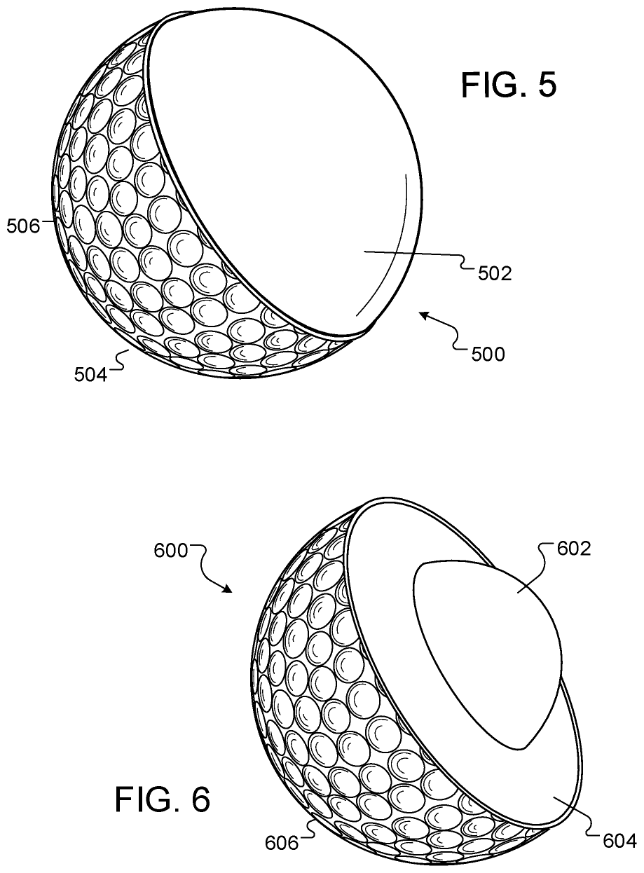

FIG. 5 is a cutaway cross-sectional diagram of a two-piece golf ball 500 formed of a core 502 and a cover 504 surrounding the core. The cover 504 is formed out of a thermoplastic ionomer, such as an ionomer resin or a urethane, e.g., polyurethane. In some examples, the cover 504 is hard (e.g., rigid) and facilitates energy transfer between the end of a golf club and the core 502. In some examples, the cover 504 is soft (e.g., flexible) and compresses upon contact with the end of the golf club. A soft cover can have different (e.g., reduced) durability compared to a hard cover. The outer surface of the cover 504 includes dimples 506 that impact, e.g., improve, aerodynamic properties of the golf ball 500. The cover 504 can be a single layer of material or a multi-layer structure, such as a double layer or triple layer structure.

The core 502 of a conventional golf ball is made of a solid material. For example, the material can be a rubber, such as butadiene, polybutadiene, styrene-butadiene, other ionomers, or other suitable materials. Other materials can be used in addition to the rubber, such as within the rubber, around the rubber, etc. In some implementations, the core 502 can include metals (e.g., tungsten, titanium, steel, etc.), ceramics, or a combination thereof.

The core 502 of the two-piece golf ball 500 is formed of an NPR material, such as an NPR foam material composed of, e.g., polymer, ceramic, metal NPR material, or combinations thereof. For instance, the core 502 can be formed of an NPR foam composed of the same material as the core of a conventional golf ball, such as an NPR rubber foam composed of butadiene, polybutadiene, styrene-butadiene; or can be formed of a thermoplastic polymer NPR foam; a viscoelastic elastomer NPR foam; a metallic NPR foam, or other suitable materials. The core 502 has a Poisson's ratio of between −1 and 0, e.g., between −0.8 and 0.

In some examples, the core 502 of the golf ball 500 is formed of an NPR-PPR composite material, such as an NPR-PPR composite foam. In some examples, the cover 504 of the two-piece golf ball 500 is also formed of an NPR material or an NPR-PPR composite material. The NPR or NPR-PPR composite nature of the core 502 imparts energy absorption characteristics and toughness to the golf ball 500.

FIG. 6 is a cutaway cross-sectional diagram of a three-piece golf ball 600 including a core 602, a mantel 604, and a cover 606 surrounding the core and mantel. The center core 602 and cover 606 of the three-piece golf ball can be similar to the core 502 and cover 504, respectively, of the two-piece golf ball 500.

The mantel 604 surrounds the core 602 of the three-piece golf ball 600. The mantel 604 of a conventional golf ball is made of a solid material. For example, the material can be a rubber, such as butadiene, polybutadiene, styrene-butadiene, other ionomers, or other suitable materials. Other materials can be used in addition to the rubber, such as within the rubber, around the rubber, etc. In some examples, the mantel 604 is formed of tightly wrapped rubber bands. The material of the mantel 604 can have different characteristics (e.g., different density) than the material of the core 602, e.g., characteristics selected to facilitate transfer of energy from the golf club to the core 602. For instance, the mantel 604 can be a softer (e.g., less rigid, more compressible) material than the material of the core 602.

In some examples, the mantel 604 is a multi-layer structure, e.g., a two- or three-layer structure. In examples containing multiple mantel layers, each mantel layer has a set of characteristics (e.g., density, hardness, etc.) that differs from the set of characteristics of at least one other mantel layer. The materials for the mantel layers have characteristics that are selected to facilitate transfer of energy from the golf club to the core 602. The mantel 604 does not need to be symmetrical; for instance, in some examples, one part of the golf ball 600 has a mantel while another part does not.

The core 602 of the three-piece golf ball 600 is formed of an NPR material, such as an NPR foam material composed of, e.g., polymer, ceramic, metal, or combinations thereof. For instance, the core 502 can be formed of an NPR foam composed of the same material as the core of a conventional golf ball, such as an NPR rubber foam composed of butadiene, polybutadiene, styrene-butadiene; or can be formed of a thermoplastic polymer NPR foam; a viscoelastic elastomer NPR foam; a metallic NPR foam, or other suitable materials. The core 502 has a Poisson's ratio of between −1 and 0, e.g., between −0.8 and 0. In some examples, the core 602 of the golf ball 600 is formed of an NPR-PPR composite material, such as an NPR-PPR composite foam. In some examples, the mantel 604 of the three-piece golf ball 600 is also formed of an NPR material, such as an NPR foam, material, or an NPR-PPR composite material, such as an NPR-PPR composite foam. For instance, one or more layers of the mantel 604 can be formed of an NPR foam composed of the same material as the mantel of a conventional golf ball, such as a NPR rubber foam composed of butadiene, polybutadiene, styrene-butadiene; or can be formed of a thermoplastic polymer NPR foam; a viscoelastic elastomer NPR foam; a metallic NPR foam, or other suitable materials. In some examples, the cover 606 of the three-piece golf ball 600 is also formed of an NPR material or an NPR-PPR composite material, such as an NPR-PPR composite foam.

The NPR composition of one or more of the core 602, the mantel 604, and the cover 06 impart energy absorption characteristics and toughness to the golf ball 600.

The presence of the mantel 604 in the three-piece golf ball 600 enables the golf ball to compress by a variable, and controllable, amount upon impact with a golf club. The compression of a golf ball upon impact with a golf club affects the flight path of the ball due to, e.g., control over the spin, distance, etc. Less compression enables a player to have more control over the spin of the ball, but means that the ball generally has a shorter launch distance. Conversely, more compression facilitates a longer launch distance, but provides less ability for the player to control the direction or spin of the ball. For instance, more compression can be desirable when driving for distance with less regard for aim or spin. A three-piece ball 600 can have more compression with some swings, such as a drive, and lower compression during other swings, such as approach shots, because of the varying compressibility of the mantel 604, thereby giving a player more control over the flight path of the ball and the ability to achieve long launch distances. By contrast, in some cases, a two-piece golf ball has a relatively constant level of compression because the golf ball is formed primarily of a single material.

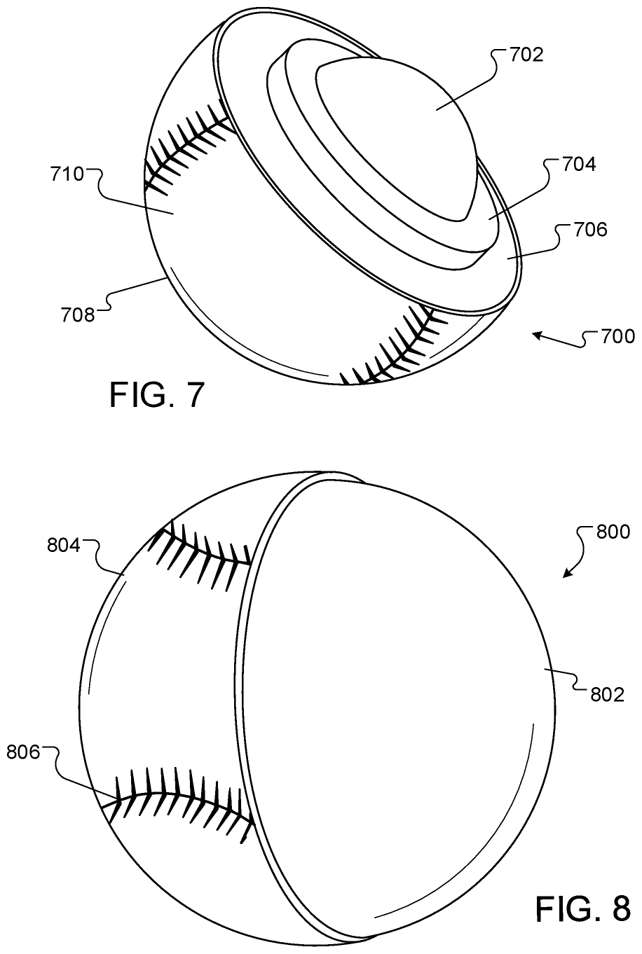

FIG. 7 is a cutaway cross-sectional diagram of a baseball 700. The baseball 700 includes a core 702. In some examples, the core 702 is formed of cork. In some examples, the core 702 is formed of an NPR material, such as an NPR foam material composed of polymer, ceramic, metal, or combinations thereof. For instance, the core 702 can be formed of an NPR foam composed of cork (e.g., the same material as the core of a conventional baseball), or can be formed of an NPR rubber foam composed of butadiene, polybutadiene, styrene-butadiene; a thermoplastic polymer NPR foam; a viscoelastic elastomer NPR foam; a metallic NPR foam, or other suitable materials. The core 502 has a Poisson's ratio of between −1 and 0, e.g., between −0.8 and 0. In some examples, the core 702 of the baseball 700 is formed of an NPR-PPR composite material, such as an NPR-PPR composite foam.

The core 702 is surrounded by a middle layer 704. In some examples, the middle layer 704 is formed of a rubber, such as butadiene, polybutadiene, styrene-butadiene, other ionomers, or other suitable materials. In some examples, the middle layer 704 is formed of an NPR material, such as an NPR foam material composed of polymer, ceramic, metal, or combinations thereof. For instance, the middle layer 704 can be formed of an NPR foam composed of the same material as the middle layer of a conventional baseball, such as a NPR rubber foam composed of butadiene, polybutadiene, styrene-butadiene; or can be formed of a thermoplastic polymer NPR foam; a viscoelastic elastomer NPR foam; a metallic NPR foam, or other suitable materials. In some examples, the middle layer 704 of the baseball 700 is formed of an NPR-PPR composite material, such as an NPR-PPR composite foam.

The baseball 700 can include two middle layers 704. In some examples, each middle layer is formed of a different type of rubber or polymer. In some examples, one or both of the middle layers 704 is formed of an NPR material (e.g., an NPR foam), such as a polymer NPR material, ceramic NPR material, metal NPR material, or combinations thereof. In some examples, one or both of the middle layers 704 are formed of an NPR-PPR composite material, such as an NPR-PPR composite foam.

The middle layer 704 is surrounded by a yarn layer 706 composed of yarn tightly wrapped around the middle layer 704. The yarn can be wool, polyester, cotton, or another appropriate material. In some examples, the ball 700 includes multiple layers 706 of yarn, e.g., with each layer being composed of a different type of yarn or with multiple of the layers being composed of the same type of yarn.

The layer of yarn 706 is surrounded by a cover 708. The cover 708 can be formed of cowhide leather, synthetic materials, or other appropriate material. The cover 708 is sewn together with a continuous seam of stitches 160.

FIG. 8 is a cutaway cross-sectional diagram of a softball 800 including a core 802 surrounded by a cover 804. The core 802 is formed of an NPR material, such as an NPR foam material composed of, e.g., polymer, ceramic, metal, or combinations thereof. For instance, the core 802 can be formed of an NPR rubber foam composed of butadiene, polybutadiene, styrene-butadiene; a thermoplastic polymer NPR foam; a viscoelastic elastomer NPR foam; a metallic NPR foam, or other suitable materials. The core 802 has a Poisson's ratio of between −1 and 0, e.g., between −0.8 and 0. In some examples, the core 802 is formed of an NPR-PPR composite material, such as an NPR-PPR composite foam. The cover 804 is formed of leather (e.g., cowhide leather), synthetic materials, or other appropriate material. The cover 804 is sewn together with one continuous seam of stitches 806.

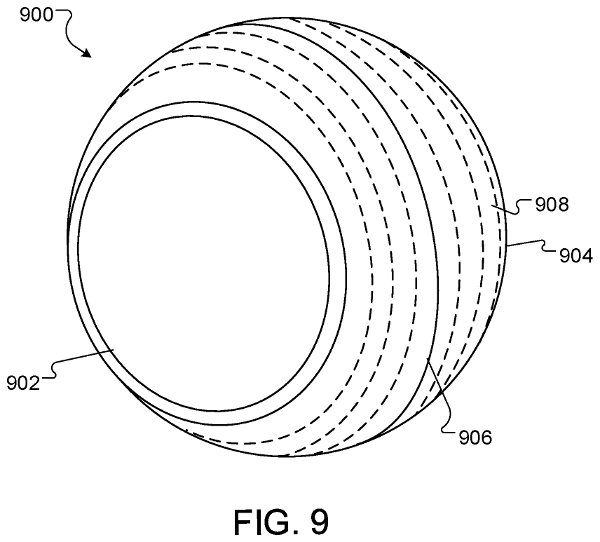

FIG. 9 is a cutaway cross-sectional diagram of a cricket ball 900. The cricket ball 900 is an irregularly-shaped ball that includes a core 902 surrounded by a cover 904. The core 902 is formed of an NPR material, such as an NPR foam material composed of, e.g., polymer, ceramic, metal, or combinations thereof. For instance, the core 902 can be formed of an NPR rubber foam composed of butadiene, polybutadiene, styrene-butadiene; a thermoplastic polymer NPR foam; a viscoelastic elastomer NPR foam; a metallic NPR foam, or other suitable materials. The core 902 has a Poisson's ratio of between −1 and 0, e.g., between −0.8 and 0. In some examples, the core 902 is formed of an NPR-PPR composite material, such as an NPR-PPR composite foam. The cover 904 is formed of leather, synthetic materials, or other appropriate material. The cover is sewn together with six seams 908, three on either side of a center line 906.

In some examples, NPR foams are produced by transformation of PPR foams to change the structure of the foam into a structure that exhibits a negative Poisson's ratio. In some examples, NPR foams are produced by transformation of nanostructured or microstructured PPR materials, such as nanospheres, microspheres, nanotubes, microtubes, or other nano- or micro-structured materials, into a foam structure that exhibits a negative Poisson's ratio. The transformation of a PPR foam or a nanostructured or microstructured material into an NPR foam can involve thermal treatment (e.g., heating, cooling, or both), application of pressure, or a combination thereof. In some examples, PPR materials, such as PPR foams or nanostructured or microstructured PPR materials, are transformed into NPR materials by chemical processes, e.g., by using glue. In some examples, NPR materials are fabricated using micromachining or lithographic techniques, e.g., by laser micromachining or lithographic patterning of thin layers of material. In some examples, NPR materials are fabricated by additive manufacturing (e.g., three-dimensional (3D) printing) techniques, such as stereolithography, selective laser sintering, or other appropriate additive manufacturing technique.

In an example, a PPR thermoplastic foam, such as an elastomeric silicone film, can be transformed into an NPR foam by compressing the PPR foam, heating the compressed foam to a temperature above its softening point, and cooling the compressed foam. In an example, a PPR foam composed of a ductile metal can be transformed into an NPR foam by uniaxially compressing the PPR foam until the foam yields, followed by uniaxially compression in other directions.

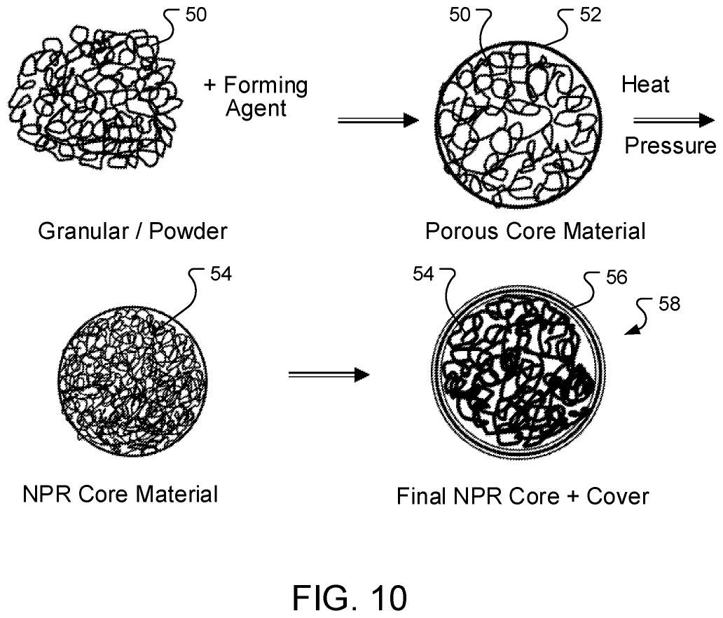

FIG. 10 illustrates an example method of making a ball, such as a golf ball, having a core formed of an NPR material, such as a golf ball. A granular or powdered material, such as a polymer material (e.g., a rubber) is mixed with a foaming agent to form a porous material 50. The porous material 50 is placed into a mold 52. Pressure is applied to compress the material 50 and the compressed material is heated to a temperature above its softening point. The material is then allowed to cool, resulting in an NPR foam 54. The NPR foam 54 is covered with an outer layer 56, such as a polymer layer, and heat and pressure is applied again to cure the final material into a ball 58.

Other methods can also be used to fabricate a ball formed of an NPR material or an NPR-PPR composite material, such as a golf ball. For example, various additive manufacturing (e.g., 3D printing) techniques, such as stereolithography, selective laser sintering, or other appropriate additive manufacturing technique, can be implemented to fabricate a ball formed of an NPR material or an NPR-PPR composite. In some examples, different components of the ball are made by different techniques. For example, the core may be 3D printed while the cover is not, or vice versa. Additive manufacturing techniques can enable seams to be eliminated. Seams on covers of conventionally manufactured balls (e.g., golf balls) can sometimes interfere with rotation or spin of the balls during flight.

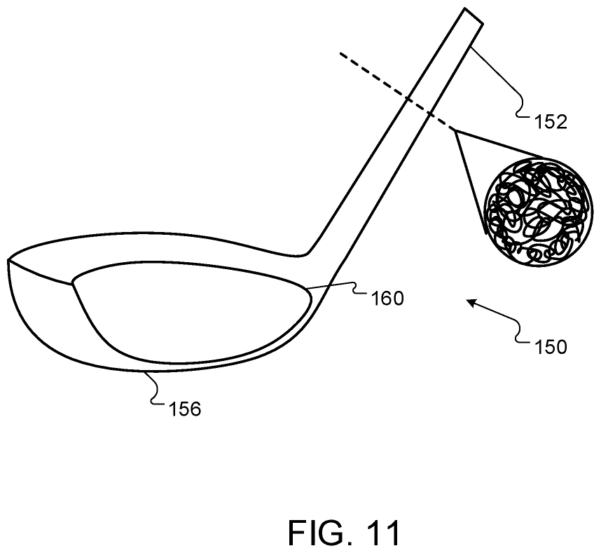

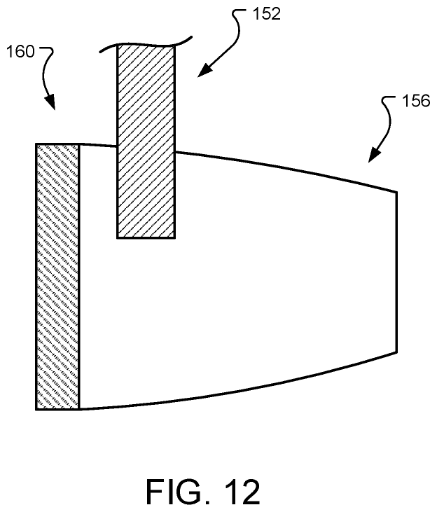

The NPR materials described here can be implemented in sports equipment other than balls. Referring to FIGS. 11 and 12, a golf club 150 includes a shaft 152 connected to a grip (not shown), with a head 156 connected to a bottom end of the shaft 152. The golf club 150 can be, e.g., a driver, a fairway wood, an iron, or another type of golf club. A face 160 defined on one side of the head is shaped and sized for contact with a golf ball. For instance, the face 160 is substantially planar, concave, or convex. In the example of FIG. 12, the face 160 is defined by a distinct face plate that is attached to the head 156. In some examples, the face 160 is a surface of the head 156, e.g., the face 160 is integral with the head.

The shaft 152, the head 156, a face 160, or a combination of any two or more of them are formed of an NPR material, such as an NPR foam material composed of polymer, ceramic, metal, or combinations thereof. For instance, the shaft 152, the head 156, a face 160, or a combination of any two or more of them can be formed of a polymer NPR foam; a metallic NPR foam composed of steel (e.g., stainless steel), titanium, aluminum, or another appropriate metal; a ceramic NPR foam composed of a metal oxide (e.g., aluminum oxide, titanium oxide, zirconium oxide), or other suitable materials. In some examples, the shaft 152, the head 156, the face 160, or a combination of any two or more of them are formed of an NPR-PPR composite material, such as an NPR-PPR composite foam. In some examples, the shaft 152, the head 156, the face 160, or a combination of any two or more of them are formed of a metal (e.g., steel, titanium, or another appropriate metal), plastic, or carbon fiber. The shaft 152, the head 156, and the face 160 can all be formed of different materials, or two or more of them can be formed of the same material. In the example of FIGS. 11 and 12, the shaft 152 and the face 160 are formed of NPR materials, and the head 156 is formed of a PPR material.

As discussed above, NPR materials have a different reaction to impact than PPR materials, and therefore a golf club formed of an NPR material or an NPR-PPR composite material has a different effect on a golf ball upon impact than does a club formed of PPR material. For example, a face formed of an NPR material or an NPR-PPR composite material is more mechanically compliant than a face formed of a PPR material, and thus can experience greater deformation upon impact with a golf ball than does a face formed of a PPR material. This compliance provided by the NPR materials or NPR-PPR composite materials can provide a player with better control of his strokes, e.g., with better control over putting. Forming portions of a golf club from an NPR material or an NPR-PPR composite material can render the club lighter, more flexible, and/or tougher, as compared to a club formed from a PPR material.

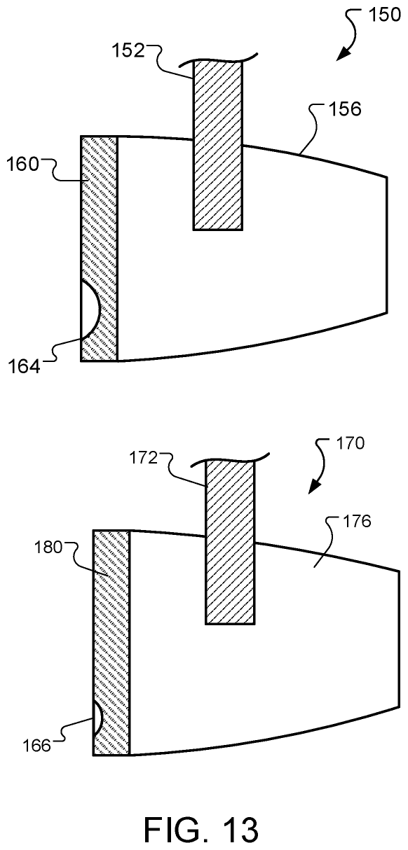

FIG. 13 shows the shaft 152, head 156, and face 160 of the golf club 150 of FIGS. 11 and 12. The shaft 152 and face 160 are formed of NPR materials, and the head 156 is formed of a PPR material. A deformation 164 forms in the NPR face 160 of the golf club 150 upon impact with a golf ball. FIG. 13 also shows golf club 170 having a shaft 172, head 176, and face 180 all formed of PPR materials. A deformation 166 forms in the PPR face 176 of the golf club 170 upon impact with a golf ball. The deformation 164 formed in the NPR face 160 is larger than the deformation 166 formed in the PPR face 176.

A golf club formed at least in part of an NPR material, an NPR-PPR composite material, or a PPR material can be made via methods disclosed herein. In some examples, golf clubs formed at least in part of NPR materials or NPR-PPR composite materials are fabricated using three-dimensional (3D) printing techniques, such as stereolithography, selective laser sintering, or other appropriate 3D printing techniques. In some examples, different components of the golf club are fabricated by different techniques. For example, the shaft may be 3D printed while the head is not, or vice versa.

In some examples, NPR materials for golf clubs are fabricated by forming nano- or micro-spheres or tubules that are then made into porous sponges. Heat and pressure are applied to the porous sponges, e.g., as described supra, to convert the sponge material into an NPR material.

As golf clubs are increasing in size (for example, up to 450±10 cm³ for the driver head volume set by the United States Golf Association (USGA)) and players are hitting balls increasingly fast (with average ball velocity over 167 mph at tee in the 2004 Augusta National Championship), the air resistance or drag by the golf club itself becomes significant. The turbulent flow (vortex) tripping or shedding of air about a dimpled golf ball in flight allows the dimpled golf ball to travel farther than a smooth, but otherwise comparable, golf ball. Dimples can be formed on golf clubs, e.g., on the head of the club, the shaft, or both, to reduce wind resistance or drag at a higher, turbulence-producing speed.

The Reynolds number (Re), which is dimensionless, is given as equation (1) for a sphere:

Rₑ=νDρ/η (1)

where v and D are the velocity and diameter of a sphere (e.g., a golf ball), and ρ and η are the density and viscosity of the medium (e.g., air), respectively. At a standard atmospheric condition, a golf ball (1.68 inch diameter), in air (density of 0.0013 g/cm³), at air absolute viscosity (3.74×10⁻⁷ lb·sec/ft²), has a Re value of 221,000 at a speed of 167 mph. A Re value above 40,000 results in turbulent flow of air around the golf ball and thus will benefit a reduced drag coefficient (CD) and an increased ball travel distance.

A golf ball also rotates (e.g., spins) as it leaves the club. The spin also affects the CD. At zero spin, the CD decreases with increasing ball speed. The CD reduction is much greater below about 27 m/sec ball speed than above this speed. The CD decreases at a certain high Reynolds number, then increases again. Without being bound by theory, this phenomenon is attributed to the vortex shedding effect of the turbulent flow of air. A similar behavior is exhibited by smooth cylinders, e.g., the shaft of a golf club. For dimpled golf balls, the threshold of reducing CD is about 40,000 Re; for roughened spheres, the threshold is between 60,000 and 100,000 Re; and for smooth spheres, the threshold is about 300,000 Re. These Re values indicate the effectiveness of tripping vortices, dimpled, roughened, and smooth surface, from the most effective to the least: a dimpled golf ball will experience less wind resistance than a smooth golf ball or a roughened golf ball, regardless of dimple size, shape, number, and depth. Beyond these Re values, the CD values reduce significantly.

A reduction in CD above a certain Reynold's number also occurs for cylinders and objects with more complex shapes. Similar to balls, a dimpled shape (e.g., a cylinder) will experience less wind resistance than the same shape that is smooth or roughened, and the CD for these shapes is reduced significantly at lower Re for dimpled shapes than for smooth shapes.

In some examples, portions of a golf club can be dimpled so that the dimpled golf clubs experiences less wind resistance than a similar, but smooth, golf club. As with golf balls, the presence of dimples on a golf club causes vortex tripping or shedding, reducing the CD of the golf club. For instance, the presence of dimples on the head and shaft of a golf club can reduce the CD when the Reynold's number of exceeds a threshold, such as 40,000. The reduced drag coefficient, and thus reduced wind resistance, results in a greater impact power with a same hitting force as compared to using a comparable, smooth club. This greater power can provide a player with better control. For instance, a player using a dimpled golf club can apply a smaller swinging force, which is easier to control, to transfer the same impact energy to the golf ball.

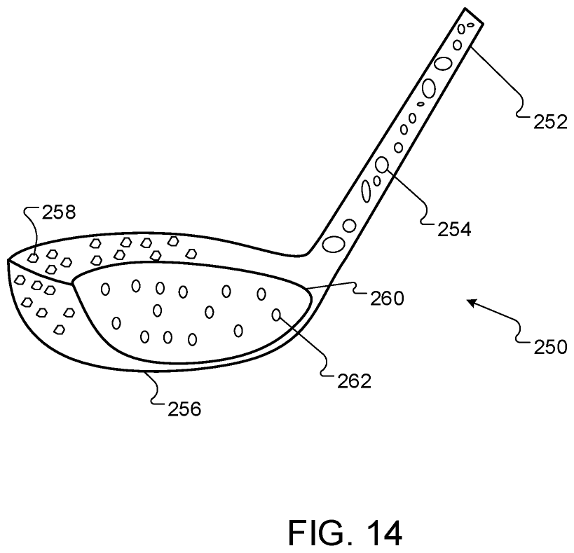

Referring to FIG. 14, a golf club 250 includes dimples configured to impact the aerodynamic performance of the golf club, e.g., by reducing drag on the portions of the golf club 250 on which the dimples are formed. Dimples are depressions or textural irregularities in a surface. The outer surface of a shaft 252 of the golf club 250 includes dimples 254. The outer surface of a head 256 of the golf club 250 includes dimples 258. A face 260 of the head 256 includes dimples 262. In some examples, the dimples 262 on the face 260 are sized, shaped, or both to match the dimples on a golf ball. The presence of dimples on the face 260 can increase the surface area of contact between the face 260 and the golf ball, thereby facilitating energy transfer from the club to the ball. The dimpled shaft 252, the dimpled head 256, and/or the dimpled face 260 can each be formed of an NPR material, an NPR-PPR composite, or a PPR material.

Each of the shaft 252, the head 256, and the face 260 can have a number of respective dimples 254, 258, 262 to achieve a desired aerodynamic effect. For example, the shaft 252 can have about 250 dimples, about 300 dimples, about 400 dimples, 500 dimples, 1000 dimples, etc. The dimples can be sized, shaped, and spaced to achieve a desired aerodynamic effect, e.g., to reduce or minimize wind resistance experienced by the golf club 250 during a swing. The spacing of the dimples can relate to the number of dimples per unit area or the total area of dimples per unit area. In some examples, all dimples on the golf club 250 are uniform in size, shape, and/or spacing. In some examples, all dimples on a given component of the golf club 250 (e.g., the shaft 252, the head 256, or the face 260) are uniform in size, shape, and/or spacing, but the size, shape, and/or spacing of the dimples varies between components. In some examples, the dimples on one or more of the components of the golf club 250 are irregular in shape, non-uniform in dimension, and/or non-uniform in spacing. In the example of FIG. 14, the dimples 254 on the shaft 252 are elliptical and non-uniform in dimension, the dimples 258 on the head 256 are irregular in shape and substantially uniform in dimension, and the dimples 262 on the face 260 are elliptical and substantially uniform in dimension. In some examples, the dimples 154 are circular, triangular, hexagonal, or any other suitable shape, e.g., a shape that achieves a desired aerodynamic effect, e.g., reduces the drag experienced by the club. In some examples, the dimples do not have sharp corners in order to reduce or minimize stress concentrations.

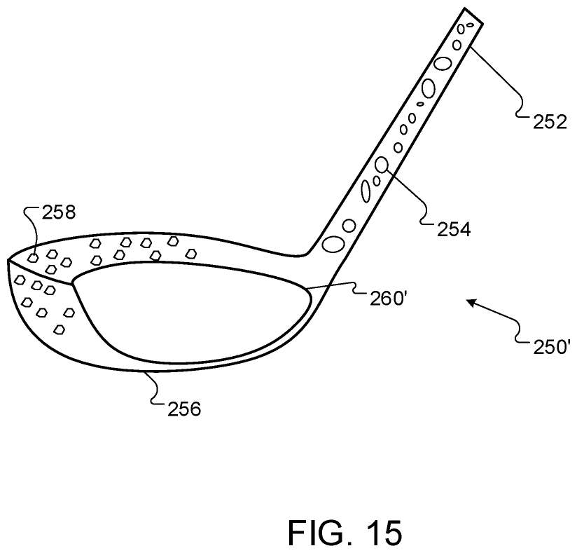

In some examples, dimples are formed on only some components of the golf club 250. For instance, surfaces of the club that initiate contact with the wind during a golf swing can remain smooth (e.g., without any dimples), such that these surfaces have low wind resistance. For instance, referring to FIG. 15, an example golf club 250′ has a face 260′ that is smooth. In some examples, the leading surface of the shaft of a golf club can be smooth, e.g., in addition to or instead of a smooth face. In some examples, portions of the head that define leading surfaces of the golf club can be smooth. In some examples, trailing surfaces of the club are smooth, e.g., in addition to or instead of having smooth leading surfaces. For instance, the back surface of the shaft and/or the head of a golf club can be smooth.

In some examples, a dimpled sheet of material, e.g., plastic, metal, ceramic, composite, or other appropriate material, is adhered to a surface of the golf club to produce a dimpled surface. The material can be a PPR material, an NPR material, or an NPR-PPR composite material. In some examples, a dimpled surface is produced by mechanical processing, such as shot peening, sand blasting, molding; chemical processing, such as etching; electrical processing, such as electrical discharge machining or electrochemical machining; laser cutting; or other suitable processes. In some examples, a dimpled surface is heat treated to relieve internal stresses accumulated during manufacturing of the surface.

1. A sports ball comprising:
a single layer core at a center of the sports ball, the single layer core comprising a negative Poisson's ratio (NPR) foam material, in which the core has a Poisson's ratio of between 0 and −1, and in which the NPR foam material comprises an NPR polymer foam; and
a cover layer surrounding the core.

2. The sports ball of claim 1, in which the NPR foam material comprises an NPR rubber foam.

3. The sports ball of claim 2, in which the NPR rubber foam comprises one or more of butadiene, polybutadiene, or styrene-butadiene.

4. The sports ball of claim 1, in which the NPR foam material comprises a thermoplastic polymer NPR foam or a viscoelastic elastomer NPR film.

5. The sports ball of claim 1, in which the core has a Poisson's ratio of between 0 and −0.8.

6. The sports ball of claim 1, in which the NPR foam material is composed of a cellular structure having a characteristic dimension of between 0.1 μm and 3 mm.

7. The sports ball of claim 1, in which the core comprises a composite material comprising the NPR foam material and a positive Poisson's ratio (PPR) material.

8. The sports ball of claim 1, comprising a middle layer surrounding the core and disposed between the core and the cover.

9. The sports ball of claim 8, in which the middle layer comprises second NPR foam material.

10. The sports ball of claim 1, in which the cover is formed of a third NPR foam material.

11. The sports ball of claim 1, in which the ball comprises a golf ball.

12. The sports ball of claim 1, in which the ball comprises a baseball or a softball.

13. The sports ball of claim 1, in which the ball comprises a cricket ball.

14. A method of making a sports ball, the method comprising:
forming a core of a sports ball from a negative Poisson's ratio (NPR) foam material, in which the NPR foam material comprises an NPR polymer foam, and in which the core has a Poisson's ratio of between 0 and −1;
disposing a cover to surround the core of the sports ball.

15. The method of claim 14, in which forming the core from an NPR material comprises heating and compressing a positive Poisson's ratio (PPR) foam material to form the NPR material.

16. The method of claim 14, in which forming the core from an NPR material comprises forming the core from nano- or micro-structured PPR materials.

17. The method of claim 14, in which forming the core from an NPR material comprises forming the core using an additive manufacturing technique.

18. A golf club comprising:
an elongated shaft;
a grip disposed at a first end of the elongated shaft; and
a head connected to a second end of the elongated shaft, the head having a flat face configured for contact with a golf ball,
in which the flat face is formed of a negative Poisson's ratio (NPR) foam material, in which the head has a Poisson's ratio of between 0 and −1, and in which the NPR foam material comprises an NPR metal foam, an NPR ceramic foam, or an NPR-PPR composite foam.

19. The golf club of claim 18, in which the head is formed of an NPR metal foam, an NPR ceramic foam, or an NPR-PPR composite foam.

20. The golf club of claim 18, in which the flat face is integral with the head.

21. The golf club of claim 18, in which dimples are defined on one or more surfaces of the golf club.

22. The golf club of claim 21, in which the flat face does not have dimples.

23. The golf club of claim 21, in which dimples are defined on a surface of the elongated shaft of the golf club.

24. The golf club of claim 21, in which dimples are defined on the head of the golf club.
